(19) United States
(12) Patent Application Publication
(10) Pub. No.: US 2022/0135872 A1
(43) Pub. Date: May 5, 2022

(54) OPTICAL WAVELENGTH CONVERSION COMPOSITE MATERIAL, RELATED MANUFACTURING METHOD AND RELATED OPTICAL WAVELENGTH CONVERSION COMPOSITE STRUCTURE

(71) Applicant: Skiileux Electricity Inc., Taoyuan City (TW)

(72) Inventors: Chien-Shou Liao, Taichung City (TW); Jian-Ging Chen, Taoyuan City (TW)

(73) Assignee: Skiileux Electricity Inc., Taoyuan City (TW)

(21) Appl. No.: 17/475,335

(22) Filed: Sep. 14, 2021

(30) Foreign Application Priority Data
Oct. 29, 2020 (TW) 109137540

(51) Int. Cl. C09K 11/02; C09K 11/66; B32B 27/36; B32B 27/08; B32B 27/28

(52) U.S. Cl. CPC C09K 11/02; C09K 11/665; B82Y 20/00; B32B 27/08; B32B 27/285; B32B 27/36

(57) ABSTRACT

An optical wavelength conversion composite material is provided and includes a first wavelength conversion material and an inorganic covering layer. The first wavelength conversion material is selected from the group consisting of a first quantum dot, a first phosphor, and a combination thereof. The inorganic covering layer covers the first wavelength conversion material, and the inorganic covering layer includes SiO₂, TiO₂ and SiₓTi_{y}O_{4-z}, wherein x is from 0.1 to 0.4, y is from 0.5 to 0.8, and z is from 0.01 to 3.99. The optical wavelength conversion composite material has improved luminous efficiency and is stable. Besides, a related manufacturing method and a related optical wavelength conversion composite structure are provided.

### BACKGROUND OF THE INVENTION

### 1. Field of the Invention

The present invention relates to an optical wavelength conversion composite material, a related manufacturing method and a related optical wavelength conversion composite structure, and more specifically, to an optical wavelength conversion composite material for Polymer Dispersed Liquid Crystal (PDLC), a related manufacturing method and a related optical wavelength conversion composite structure.

### 2. Description of the Prior Art

In recent years, with advancement of display technology, requirements for quality of displays or light sources are getting higher and higher. Polymer Dispersed Liquid Crystal (PDLC) is a composite liquid crystal material with unique photoelectric properties. Principle of the PDLC is provided as below. After small molecule liquid crystal materials and polymers are mixed, liquid crystal molecules can be dispersed from the polymers due to phase separation of the polymers under an external influence, so as to form a film with a display function or a dimming function. Currently, since a PDLC film has advantages of unique photoelectric properties, simple manufacturing process, low cost, etc., and therefore, the PDLC film is widely used in photoelectric control devices, projection displays, electrically controlled glass, gratings, etc.

In addition, although a phosphor has a lower manufacturing cost than a quantum dot, color rendering of the phosphor is poor, and a size of the phosphor differs greatly from a size of the quantum dot. Besides, when the phosphors and the quantum dots are used together, there are still problems with mixing uniformity and self-absorption. Therefore, how to improve luminescence characteristics and color saturation by using the phosphors and the quantum dots together is an urgent problem to be solved.

### SUMMARY OF THE INVENTION

It is an objective of the present invention to provide an optical wavelength conversion composite material with improved luminescence characteristics and color saturation, a related manufacturing method and a related optical wavelength conversion composite structure for solving the aforementioned problems.

In order to achieve the aforementioned objective, the present invention discloses an optical wavelength conversion composite material. The optical wavelength conversion composite material includes a first wavelength conversion material and an inorganic covering layer. The first wavelength conversion material is selected from the group consisting of a first quantum dot, a first phosphor, and a combination thereof. The inorganic covering layer covers the first wavelength conversion material, and the inorganic covering layer includes SiO₂, TiO₂ and SiₓTi_{y}O_{4-z}, wherein x is from 0.1 to 0.4, y is from 0.5 to 0.8, and z is from 0.01 to 3.99.

According to an embodiment of the present invention, the optical wavelength conversion composite material further includes a silicone polymer layer covering the inorganic covering layer. The silicone polymer layer includes a second wavelength conversion material dispersed evenly. The second wavelength conversion material is selected from the group consisting of a second quantum dot, a second phosphor, and a combination thereof, and the second wavelength conversion material is identical to or different from the first wavelength conversion composite material.

According to an embodiment of the present invention, the silicone polymer layer is made of polysiloxane or polysilazane.

According to an embodiment of the present invention, the first quantum dot or the second quantum dot is an all-inorganic perovskite quantum dot selected from the group consisting of CsPbCl₃ exhibiting blue emission, CsPbBr₃ exhibiting green emission, CsPbI₃ exhibiting red emission, and combinations thereof.

According to an embodiment of the present invention, the first phosphor or the second phosphor is a fluoride phosphor selected from the group consisting of fluosilicate (K₂SiF₆:Mn⁴⁺, KSF), fluotitanate (K₂TiF₆:Mn⁴⁺, KTF), fluogermanate (K₂GeF₆:Mn⁴⁺, KGF), and combinations thereof.

According to an embodiment of the present invention, the first quantum dot or the second quantum dot is an all-inorganic perovskite quantum dot selected from the group consisting of CsPbCl₃ exhibiting blue emission, CsPbBr₃ exhibiting green emission, CsPbI₃ exhibiting red emission, and combinations thereof.

According to an embodiment of the present invention, the first phosphor or the second phosphor is a fluoride phosphor selected from the group consisting of fluosilicate (K₂SiF₆:Mn⁴⁺, KSF), fluotitanate (K₂TiF₆:Mn⁴⁺, KTF), fluogermanate (K₂GeF₆:Mn⁴⁺, KGF), and combinations thereof.

In order to achieve the aforementioned objective, the present invention further discloses a manufacturing method of an optical wavelength conversion composite material. The manufacturing method includes a mixing step and a miniaturization step. The mixing step includes mixing a first wavelength conversion material and an inorganic oxide to form a light emitting composite mixture, wherein the inorganic oxide includes SiO₂, TiO₂ and SiₓTi_{y}O_{4-z}, and x is from 0.1 to 0.4, y is from 0.5 to 0.8, z is from 0.01 to 3.99. The miniaturization step includes micronizing the light emitting composite mixture by spray drying method to obtain the optical wavelength conversion composite material.

According to an embodiment of the present invention, the manufacturing method further includes a silane treatment step. The silane treatment step includes mixing the light emitting composite mixture, a polysilane compound and a second wavelength conversion material, so as to generate a silane treated light emitting composite mixture.

According to an embodiment of the present invention, a precursor of the inorganic oxide is selected from the group consisting of tetraethoxysilane (TEOS), tetramethoxysilane (TMOS), 3-Aminopropyltriethoxysilane (APTES), titanium isopropoxide (TTIP), tetrabutyl orthotitanate (TBOT), and combinations thereof.

In order to achieve the aforementioned objective, the present invention further discloses an optical wavelength conversion composite structure. The optical wavelength conversion composite structure includes a first base plate, an optical wavelength conversion composite material layer and a second base plate. The optical wavelength conversion composite material layer is disposed on the first base plate. The optical wavelength conversion composite material layer includes an optical wavelength conversion composite material. The optical wavelength conversion composite material includes a first wavelength conversion material and an inorganic covering layer. The first wavelength conversion material is selected from the group consisting of a first quantum dot, a first phosphor, and a combination thereof. The inorganic covering layer covers the first wavelength conversion material, and the inorganic covering layer includes SiO₂, TiO₂ and SiₓTi_{y}O_{4-z}, wherein x is from 0.1 to 0.4, y is from 0.5 to 0.8, and z is from 0.01 to 3.99. The second base plate is disposed on the optical wavelength conversion composite material layer, so that the optical wavelength conversion composite material layer is clamped by the first base plate and the second base plate.

According to an embodiment of the present invention, the optical wavelength conversion composite material further includes a silicone polymer layer covering the inorganic covering layer. The silicone polymer layer includes a second wavelength conversion material dispersed evenly. The second wavelength conversion material is selected from the group consisting of a second quantum dot, a second phosphor, and a combination thereof, and the second wavelength conversion material is identical to or different from the first wavelength conversion composite material.

According to an embodiment of the present invention, the silicone polymer layer is made of polysiloxane or polysilazane.

According to an embodiment of the present invention, the first quantum dot or the second quantum dot is an all-inorganic perovskite quantum dot selected from the group consisting of CsPbCl₃ exhibiting blue emission, CsPbBr₃ exhibiting green emission, CsPbI₃ exhibiting red emission, and combinations thereof.

According to an embodiment of the present invention, the first phosphor or the second phosphor is a fluoride phosphor selected from the group consisting of fluosilicate (K₂SiF₆:Mn⁴+, KSF), fluotitanate (K₂TiF₆:Mn⁴⁺, KTF), fluogermanate (K₂GeF₆:Mn⁴⁺, KGF), and combinations thereof.

According to an embodiment of the present invention, the first quantum dot or the second quantum dot is an all-inorganic perovskite quantum dot selected from the group consisting of CsPbCl₃ exhibiting blue emission, CsPbBr₃ exhibiting green emission, CsPbI₃ exhibiting red emission, and combinations thereof.

According to an embodiment of the present invention, the first phosphor or the second phosphor is a fluoride phosphor selected from the group consisting of fluosilicate (K₂SiF₆:Mn⁴+, KSF), fluotitanate (K₂TiF₆:Mn⁴⁺, KTF), fluogermanate (K₂GeF₆:Mn⁴⁺, KGF), and combinations thereof.

In summary, since the inorganic covering layer of the present invention includes SiO₂, TiO₂ and SiₓTi_{y}O_{4-z}, wherein x is from 0.1 to 0.4, y is from 0.5 to 0.8, and z is from 0.01 to 3.99, the optical wavelength conversion composite material of the present invention has improved luminescence characteristics and color saturation. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an optical wavelength conversion composite material according to an embodiment of the present invention.

FIG. 2 is a diagram of an optical wavelength conversion composite material according to another embodiment of the present invention.

FIG. 3 is a flow chart of a manufacturing method of an optical wavelength conversion composite material according to an embodiment of the present invention.

FIG. 4 is a flow chart of a manufacturing method of an optical wavelength conversion composite material according to another embodiment of the present invention.

FIG. 5 is a diagram of an optical wavelength conversion composite structure according to an embodiment of the present invention.

### DETAILED DESCRIPTION

In order to illustrate technical specifications and features as well as achieved purposes and effects of the present invention, relevant embodiments and figures are described as follows. The drawings and descriptions will be regarded as illustrative in nature and not as restrictive. Also, the term “or” is intended to include any one or a combination of more than one of the associated listed items.

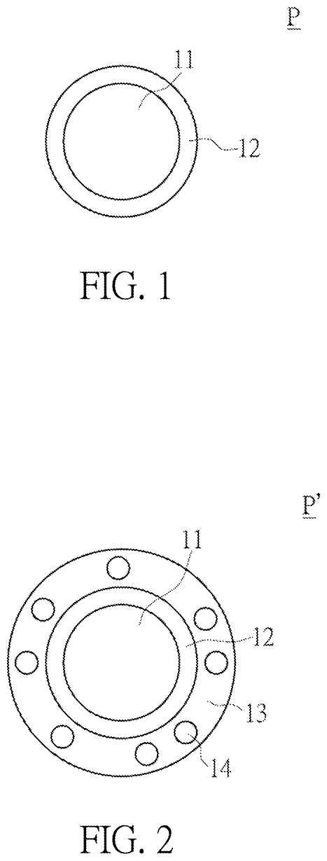

Please refer to FIG. 1. FIG. 1 is a diagram of an optical wavelength conversion composite material P according to an embodiment of the present invention. As shown in FIG. 1, the optical wavelength conversion composite material P includes a first wavelength conversion material 11 and an inorganic covering layer 12 covering the first wavelength conversion material 11.

Please refer to FIG. 2. FIG. 2 is a diagram of an optical wavelength conversion composite material P′ according to another embodiment of the present invention. As shown in FIG. 2, the optical wavelength conversion composite material P′ includes the first wavelength conversion material 11 and the inorganic covering layer 12 covering the first wavelength conversion material 11, and the optical wavelength conversion composite material P′ further includes a silicone polymer layer 13 covering the inorganic covering layer 12. The silicone polymer layer 13 includes at least one second wavelength conversion material 14 dispersed evenly, and the second wavelength conversion material 14 can be identical to or different from the first wavelength conversion composite material 11.

Specifically, the first wavelength conversion composite material 11 is selected from the group consisting of a first quantum dot, a first phosphor, and a combination thereof, and the second wavelength conversion composite material 14 is selected from the group consisting of a second quantum dot, a second phosphor, and a combination thereof. By using multiples quantum dots and/or phosphors with different emission wavelengths, emission spectrum of a light emitting device and color gamut of a display device can be improved effectively. Also, color purity and color authenticity of the display device can be improved effectively, and the NTSC color space can be greatly improved.

More specifically, the first quantum dot or the second quantum dot can be selected from the group consisting of a group II-VI quantum dot, a group III-V quantum dot, and a perovskite quantum dot, and the first quantum dot or the second quantum dot can be a red quantum dot, a green quantum dot or a blue quantum dot.

For example, the group II-VI quantum dot can be selected from the group consisting of a CdSe quantum dot, a CdS quantum dot, a CdTe quantum dot, a ZnSe quantum dot, a ZnS quantum dot, a ZnTe quantum dot, a CdZnS quantum dot, a CdZnSe quantum dot, a CdZnSe quantum dot, a ZnSeS quantum dot, a ZnSeTe quantum dot, a ZnTeS quantum dot, a CdSeS quantum dot, a CdSeTe quantum dot, a CdTeS quantum dot, a CdZnSeS quantum dot, a CdZnSeTe quantum dot, and CdZnSTe quantum dot.

For example, the group III-V quantum dot can be selected from the group consisting of an InP quantum dot, an InAs quantum dot, a GaP quantum dot, a GaAs quantum dot, a GaSb quantum dot, an AlN quantum dot, an AlP quantum dot, an InAsP quantum dot, an InNP quantum dot, an InNSb quantum dot, a GaAlNP quantum dot, and an InAlNP quantum dot.

Preferably, each of the first quantum dot and the second quantum dot can be the perovskite quantum dot, wherein the perovskite quantum dot is selected from the group consisting of a CH₃NH₃PbI₃ quantum dot, a CH₃NH₃PbCl₃ quantum dot, a CH₃NH₃PbBr₃ quantum dot, a CH₃NH₃PbI₂Cl quantum dot, a CH₃NH₃PbICl₂ quantum dot, a CH₃NH₃PbI₂Br quantum dot, a CH₃NH₃PbIBr₂ quantum dot, a CH₃NH₃PbIClBr quantum dot, a CsPbI₃ quantum dot, a CsPbCl₃ quantum dot, a CsPbBr₃ quantum dot, a CsPbI₂Cl quantum dot, a CsPbICl₂ quantum dot, a CsPbI₂Br quantum dot, a CsPbIBr₂ quantum dot and a CsPbIClBr quantum dot. Preferably, each of the first quantum dot and the second quantum dot can be selected from the group consisting of CsPbCl₃ exhibiting blue emission, CsPbBr₃ exhibiting green emission, and CsPbI₃ exhibiting red emission

In detail, each of the first phosphor and the second phosphor can be selected from the group consisting of LuYAG, GaYAG, YAG, silicate (such as Ba₂SiO₄:Eu²⁺, Sr₂SiO₄:Eu²⁺, (Mg, Ca, Sr, Ba)₃Si₂O₇:Eu²⁺, Ca₈Mg (SiO₄)₄Cl₂:Eu²⁺ (CS), (Mg, Ca, Sr, Ba)₂SiO₄:Eu²⁺, SLA, KSF, SILION, sulfide (such as SrS:Eu²⁺, SrGa₂S₄:Eu²⁺, ZnS:Cu⁺, ZnS:Ag⁺, Y₂O₂S:Eu²⁺, La₂O₂S:Eu²⁺, Gd₂O₂S:Eu²⁺, SrGa₂S₄:Ce³⁺, ZnS:Mn²⁺, SrS:Eu²⁺, CaS:Eu²⁺, (Sr₁₋ₓCaₓ) S:Eu²⁺), nitride (such as (Ca, Mg, Y) Si_{w}AlₓO_{y}N_{z}:Ce²⁺, Ca₂Si₅N₈:Eu²⁺, (Ca, Mg, Y) Si_{w}AlₓO_{y}N_{z}:Eu²⁺, (Sr, Ca, Ba) SiₓO_{y}N_{z:}Eu²⁺), and fluoride (such as fluosilicate (K₂SiF₆:Mn⁴⁺;KSF), fluotitanate (K₂TiF₆:Mn⁴⁺;KTF), fluogermanate (K₂GeF₆:Mn⁴⁺;KGF)).

Preferably, each of the first phosphor and the second phosphor can be a fluoride phosphor and selected from the group consisting of fluosilicate (K₂SiF₆:Mn⁴⁺;KSF), fluotitanate (K₂TiF₆:Mn⁴⁺;KTF), fluogermanate (K₂GeF₆:Mn⁴⁺;KGF).

For example, the first wavelength conversion material and the second wavelength conversion material of the optical wavelength conversion composite material P′ can be fluosilicate (KSF) and CsPbBr₃ exhibiting green emission, respectively.

The inorganic covering layer 12 includes SiO₂, TiO₂ and SiₓTi_{y}O_{4-z}, wherein x is from 0.1 to 0.4, y is from 0.5 to 0.8, and z is from 0.01 to 3.99. Specifically, the inorganic covering layer 12 is made of a mixture of SiO₂ and TiO₂. Preferably, SiₓTi_{y}O_{4-z} can be Si_{0.1}Ti_{0.5}O_{3.95}. More preferably, SiₓTi_{y}O_{4-z} can be Si_{0.2}Ti_{0.6}O_{3.95}.

Besides, the silicone polymer layer 13 is made of polysiloxane and/or polysilazane.

Furthermore, polysiloxane and/or polysilazane are used to provide a source of silicon to form the inorganic covering layer 12 made of silicon oxide, silicon nitride or silicon oxynitride to cover the second wavelength conversion material. Preferably, a weight ratio of polysiloxane and/or polysilazane to the second wavelength conversion material is from 10:1 to 1000:1, so as to obtain the inorganic covering layer 12 with a thickness between about 10 nm to 10 μm. Preferably, a molecular weight of polysiloxane or a molecular weight of polysilazane can be from about 500 to 5,000 g/mol. Preferably, a particle diameter of the optical wavelength conversion composite material is from 50 nanometers (nm) to 5 micrometers (μm).

However, the above-mentioned example is only one of the feasible embodiments and is not intended to limit the present invention.

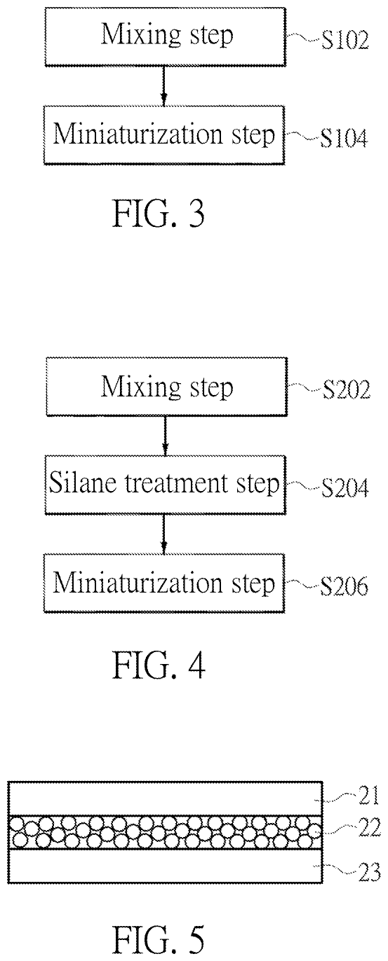

Please refer to FIG. 3. FIG. 3 is a flow chart of a manufacturing method of the optical wavelength conversion composite material according to an embodiment of the present invention. As shown in FIG. 3, the manufacturing method includes a mixing step S102 and a miniaturization step S104. Specifically, the mixing step S102 includes mixing a first wavelength conversion material and an inorganic oxide to form a light emitting composite mixture, wherein the inorganic oxide includes SiO₂, TiO₂ and SiₓTi_{y}O₄, and x is from 0.1 to 0.4, y is from 0.5 to 0.8, z is from 0.01 to 3.99. The miniaturization step S104 includes micronizing the light emitting composite mixture by spray drying method to obtain the optical wavelength conversion composite material.

Specifically, in this embodiment, a precursor of the inorganic oxide is selected from the group consisting of tetraethoxysilane (TEOS), tetramethoxysilane (TMOS), 3-Aminopropyltriethoxysilane (APTES), titanium isopropoxide (TTIP), tetrabutyl orthotitanate (TBOT), and combinations thereof. Preferably, the precursor of the inorganic oxide can be a mixture of TMOS and TTIP for manufacturing the inorganic covering layer made of SiₓTi_{y}O_{4-z}, which has a higher synthesis rate than a mixture of TEOS and TMOS.

In detail, a weight ratio of the first wavelength conversion material to the whole optical wavelength conversion composite material is not limited. Preferably, the weight ratio of the of the first wavelength conversion material to the whole optical wavelength conversion composite material can be from 0.01 to 10 wt %, which has better aggregation characteristics and better luminescence. Furthermore, an average particle diameter of the first wavelength conversion material is not limited. Preferably, the average particle diameter of the first wavelength conversion material can be from 1 nm to 50 nm, or less, which maintains a better crystal structure.

Optionally, a solvent may be further added as a medium for dispersing the first wavelength conversion material. For example, the solvent can be ester (such as methyl formate, ethyl formate, propyl formate, pentyl formate, methyl acetate, ethyl acetate, pentyl acetate), or ketone (such as y-butyrolactone, N-methyl-2-pyrrolidone, acetone, dimethyl ketone, diisobutyl ketone, cyclopentanone, cyclohexanone, methyl cyclohexanone), or ether (such as diethyl ether, methyl tert-butyl ether, diisopropyl ether, dimethoxymethane, dimethoxyethane, 1,4-dioxane, 1,3-dioxolane, 4-methyldioxolane, tetrahydrofuran, methyltetrahydrofuran, anisole, phenylethyl ether), or alcohol (such as methanol, ethanol, 1-propanol, 2-propanol, 1-butanol, 2-butanol, tert-butanol, 1-pentanol, 2-methyl-2-butanol, methoxypropanol, diacetone alcohol, cyclohexanol, 2-fluoroethanol, 2, 2, 2-trifluoroethanol, 2, 2, 3, 3-tetrafluoro-l-propanol), or glycol ether (such as Ethylene glycol monomethyl ether, ethylene glycol monoethyl ether, ethylene glycol monobutyl ether, ethylene glycol monoethyl ether acetate, triethylene glycol dimethyl ether), or organic solvent with amide group (such as N, N-dimethylformamide, acetamide, N, N-dimethylacetamide), or organic solvent with nitrile group (such as acetonitrile, isobutyronitrile, propionitrile, methoxyacetonitrile), or organic solvent with carbonate group (such as ethylene carbonate, propylene carbonate), or organic solvent with halogenated hydrocarbon group (such as dichloromethane, chloroform), or organic solvent with hydrocarbyl group (such as n-pentane, cyclohexane, n-hexane, benzene, toluene, xylene), or dimethyl sulfoxide.

In the miniaturization step S104, the spray drying method is configured to remove liquid from the dispersion with a carrier gas selected from air, inert gas (such as argon) or nitrogen at an inlet temperature ranging from 150° C. to 500° C., so as to form optical wavelength conversion composite microspheres whose first wavelength conversion material is covered by the inorganic oxide, by curing.

Preferably, the carrier gas for spray drying can be nitrogen, wherein a pressure can be from 0.30 MPa to 0.50 MPa, and a nozzle speed can be from 500 ml/hour to 3000 ml/hour, or from 1000 ml/hour to 2000 ml/hour, or about 1760 ml/hour.

Preferably, an average particle diameter of the optical wavelength conversion composite microspheres whose first wavelength conversion material is covered by the inorganic oxide, manufactured by the spray drying method is from 10 nm to 30 μm. It depends on a ratio of solution formulation and setting conditions of the spray drying method.

Please refer to FIG. 4. FIG. 4 is a flow chart of a manufacturing method of an optical wavelength conversion composite material according to another embodiment of the present invention. As shown in FIG. 4, the manufacturing method includes a mixing step S202, a silane treatment step S204, and a miniaturization step S206. Specifically, the mixing step S202 includes mixing a first wavelength conversion material and an inorganic oxide to form a light emitting composite mixture, wherein the inorganic oxide includes SiO₂, TiO₂ and SiₓTi_{y}O_{4-z}, and x is from 0.1 to 0.4, y is from 0.5 to 0.8, z is from 0.01 to 3.99. The silane treatment step S204 includes mixing the light emitting composite mixture, a polysilane compound and a second wavelength conversion material, so as to generate a silane treated light emitting composite mixture. The miniaturization step S206 includes micronizing the silane treated light emitting composite mixture by spray drying method to obtain the optical wavelength conversion composite material.

The mixing step S202 and the miniaturization step S206 of this embodiment are the same as the mixing step 5102 and the miniaturization step S104 of the embodiment of FIG. 3. Detailed description is omitted herein for simplicity.

Different from the embodiment of FIG. 3, the silane treatment step S204 is used to generate the silane treated light emitting composite mixture by mixing the light emitting composite mixture, the polysilane compound and the second wavelength conversion material.

Specifically, in this embodiment, a precursor of the inorganic oxide is selected from the group consisting of tetraethoxysilane (TEOS), tetramethoxysilane (TMOS), 3-Aminopropyltriethoxysilane (APTES), titanium isopropoxide (TTIP), tetrabutyl orthotitanate (TBOT), and combinations thereof. Preferably, the precursor of the inorganic oxide can be a mixture of TMOS and TTIP for manufacturing the inorganic covering layer made of SiₓTi_{y}O_{4-z}, which has a higher synthesis rate than a mixture of TEOS and TMOS.

Please refer to FIG. 5. FIG. 5 is a diagram of an optical wavelength conversion composite structure according to an embodiment of the present invention. As shown in FIG. 5, the optical wavelength conversion composite structure includes a first base plate 21, an optical wavelength conversion composite material layer 22 and a second base plate 23. The optical wavelength conversion composite material layer 22 is disposed on the first base plate 21. The second base plate 23 is disposed on the optical wavelength conversion composite material layer 22, so that the optical wavelength conversion composite material layer 22 is located between and clamped by the first base plate 21 and the second base plate 23.

Preferably, each of the first base plate 21 and the second base plate 23 can be a flexible substrate or a glass substrate. The flexible substrate can be a substrate made of polyethylene terephthalate (PET), polyethylene dicarboxylate (PEN), or polyether sulfite resin (PES resin). Preferably, the first base plate 21 and the second base plate 23 can be a substrate made of polyethylene terephthalate (PET).

The optical wavelength conversion composite material layer 22 includes an optical wavelength conversion composite material. The optical wavelength conversion composite material of this embodiment is the same as the optical wavelength conversion composite material of any one of the aforementioned embodiments. Detailed description is omitted herein for simplicity.

In detail, a manufacturing method of the optical wavelength conversion composite structure includes mixing and stirring the optical wavelength conversion composite material, dispersion medium and photoinitiator into a solution; coating the solution between the first base plate and the second base plate; pressing the first base plate and the second base plate by rollers to obtain a laminated substrate with a fixed thickness; and curing the laminated substrate with ultraviolet light to obtain optical wavelength conversion composite structure.

In summary, since the inorganic covering layer of the present invention includes SiO₂, TiO₂ and SiₓTi_{y}O_{4-z}, wherein x is from 0.1 to 0.4, y is from 0.5 to 0.8, and z is from 0.01 to 3.99, the optical wavelength conversion composite material of the present invention has improved luminescence characteristics and color saturation.

Besides, the related manufacturing methods of the present application are easy and safe, and the miniaturization step can increase uniformity of the optical wavelength conversion composite material.

Furthermore, the optical wavelength conversion composite material of the present application has improved luminous efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical wavelength conversion composite material comprising:
a first wavelength conversion material selected from the group consisting of a first quantum dot, a first phosphor, and a combination thereof; and
an inorganic covering layer covering the first wavelength conversion material, and the inorganic covering layer comprising SiO₂, TiO₂ and SiₓTi_{y}O_{4-z}, wherein x is from 0.1 to 0.4, y is from 0.5 to 0.8, and z is from 0.01 to 3.99.

2. The optical wavelength conversion composite material of claim 1, further comprising a silicone polymer layer covering the inorganic covering layer, the silicone polymer layer comprising a second wavelength conversion material dispersed evenly, the second wavelength conversion material being selected from the group consisting of a second quantum dot, a second phosphor, and a combination thereof, and the second wavelength conversion material being identical to or different from the first wavelength conversion composite material.

3. The optical wavelength conversion composite material of claim 2, wherein the silicone polymer layer is made of polysiloxane or polysilazane.

4. The optical wavelength conversion composite material of claim 2, wherein the first quantum dot or the second quantum dot is an all-inorganic perovskite quantum dot selected from the group consisting of CsPbCl₃ exhibiting blue emission, CsPbBr₃ exhibiting green emission, CsPbI₃exhibiting red emission, and combinations thereof.

5. The optical wavelength conversion composite material of claim 2, wherein the first phosphor or the second phosphor is a fluoride phosphor selected from the group consisting of fluosilicate (K₂SiF₆:Mn⁴⁺, KSF), fluotitanate (K₂TiF₆:Mn⁴⁺, KTF), fluogermanate (K₂GeF₆:Mn⁴⁺, KGF), and combinations thereof.

6. The optical wavelength conversion composite material of claim 1, wherein the first quantum dot or the second quantum dot is an all-inorganic perovskite quantum dot selected from the group consisting of CsPbCl₃ exhibiting blue emission, CsPbBr₃ exhibiting green emission, CsPbI₃ exhibiting red emission, and combinations thereof.

7. The optical wavelength conversion composite material of claim 1, wherein the first phosphor or the second phosphor is a fluoride phosphor selected from the group consisting of fluosilicate (K₂SiF₆:Mn⁴⁺, KSF), fluotitanate (K₂TiF₆:Mn⁴⁺, KTF), fluogermanate (K₂GeF₆:Mn⁴⁺, KGF), and combinations thereof.

8. A manufacturing method of an optical wavelength conversion composite material comprising:
a mixing step comprising:
mixing a first wavelength conversion material and an inorganic oxide to form a light emitting composite mixture, wherein the inorganic oxide comprises SiO₂, TiO₂ and SiₓTi_{y}O_{4-z}, and x is from 0.1 to 0.4, y is from 0.5 to 0.8, z is from 0.01 to 3.99; and
a miniaturization step comprising:
micronizing the light emitting composite mixture by spray drying method to obtain the optical wavelength conversion composite material.

9. The manufacturing method of claim 8, further comprising:
a silane treatment step comprising:
mixing the light emitting composite mixture, a polysilane compound and a second wavelength conversion material, so as to generate a silane treated light emitting composite mixture.

10. The manufacturing method of claim 8, wherein a precursor of the inorganic oxide is selected from the group consisting of tetraethoxysilane (TEOS), tetramethoxysilane (TMOS), 3-Aminopropyltriethoxysilane (APTES), titanium isopropoxide (TTIP), tetrabutyl orthotitanate (TBOT), and combinations thereof.

11. An optical wavelength conversion composite structure comprising:
a first base plate;
an optical wavelength conversion composite material layer disposed on the first base plate, the optical wavelength conversion composite material layer comprising an optical wavelength conversion composite material, the optical wavelength conversion composite material comprising:
a first wavelength conversion material selected from the group consisting of a first quantum dot, a first phosphor, and a combination thereof; and
an inorganic covering layer covering the first wavelength conversion material, and the inorganic covering layer comprising SiO₂, TiO₂ and SiₓTi_{y}O_{4-z}, wherein x is from 0.1 to 0.4, y is from 0.5 to 0.8, and z is from 0.01 to 3.99; and
a second base plate disposed on the optical wavelength conversion composite material layer, so that the optical wavelength conversion composite material layer is clamped by the first base plate and the second base plate.

12. The optical wavelength conversion composite structure of claim 11, wherein the optical wavelength conversion composite material further comprises a silicone polymer layer covering the inorganic covering layer, the silicone polymer layer comprises a second wavelength conversion material dispersed evenly, the second wavelength conversion material is selected from the group consisting of a second quantum dot, a second phosphor, and a combination thereof, and the second wavelength conversion material is identical to or different from the first wavelength conversion composite material.

13. The optical wavelength conversion composite structure of claim 12, wherein the silicone polymer layer is made of polysiloxane or polysilazane.

14. The optical wavelength conversion composite structure of claim 12, wherein the first quantum dot or the second quantum dot is an all-inorganic perovskite quantum dot selected from the group consisting of CsPbCl₃ exhibiting blue emission, CsPbBr₃ exhibiting green emission, CsPbI₃ exhibiting red emission, and combinations thereof.

15. The optical wavelength conversion composite structure of claim 12, wherein the first phosphor or the second phosphor is a fluoride phosphor selected from the group consisting of fluosilicate (K₂SiF₆:Mn⁴⁺, KSF), fluotitanate (K₂TiF₆:Mn⁴⁺, KTF), fluogermanate (K₂GeF₆:Mn⁴⁺, KGF), and combinations thereof.

16. The optical wavelength conversion composite structure of claim 11, wherein the first quantum dot or the second quantum dot is an all-inorganic perovskite quantum dot selected from the group consisting of CsPbCl₃ exhibiting blue emission, CsPbBr₃ exhibiting green emission, CsPbI₃ exhibiting red emission, and combinations thereof.

17. The optical wavelength conversion composite structure of claim 11, wherein the first phosphor or the second phosphor is a fluoride phosphor selected from the group consisting of fluosilicate (K₂SiF₆:Mn⁴⁺, KSF), fluotitanate (K₂TiF₆:Mn⁴⁺, KTF), fluogermanate (K₂GeF₆:Mn⁴⁺, KGF), and combinations thereof.
